(19) United States
(12) Patent Application Publication
(10) Pub. No.: US 2002/0120427 A1
(43) Pub. Date: Aug. 29, 2002

(54) Method and apparatus for determining the molecular weight of polymers

(76) Inventor: Dirk Schubert, Leutershausen (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/056,798

(22) Filed: Jan. 18, 2002

(30) Foreign Application Priority Data
Jan. 20, 2001 (DE) 101 02 623.4

(51) Int. Cl. G06F 15/00

(52) U.S. Cl. 702/183

(57) ABSTRACT

In a method and an apparatus for determining the molecular weight of polymers, a thin layer of a polymer whose molecular weight is to be determined is formed on a substrate, the thickness of the polymer layer is determined by an ellipsometer which is disposed above the substrate and the molecular weight derived from the thickness of the polymer layer as determined by the ellipsometer.

### BACKGROUND OF THE INVENTION

The invention relates to a method for determining the molecular weight of polymers and to an apparatus with which the method can be performed.

In the field of polymer chemistry, it is often useful if not necessary, to obtain information concerning the molecular weight of the polymer produced during a polymerization. This is not only desirable or even necessary for a particular production procedure, but also for the process control for a continuous on-line quality control and assurance of the polymer being manufactured. Chemical polymers are utilized in almost all technical, commercial and private areas so that there is a large need for surveillance equipment with which the molecular weight of polymers can be determined reliably and with high accuracy since it is possible for an expert to judge from the molecular weight the type and structure of the polymer.

Conventional methods for determining the molecular weight of polymers have the disadvantage that they are relatively complex and very slow and furthermore inaccurate and unreliable so that they cannot be integrated into a production process for on-line monitoring and control of a polymerization plant. The molecular weight has been determined up to now for example by osmometry, light diffusion, gel permeation chromatography etc.

It is the object of the present invention to provide a method and an apparatus for a rapid reliable and highly accurate determination of the molecular weight of polymers. The method should also be suitable for integration into a production process for an online control of the production and process surveillance. The apparatus should be simple and easy to manufacture at least partially from commercially available components so that it can be provided relatively inexpensively and it should be capable of performing the method according to the invention simply and rapidly.

### SUMMARY OF THE INVENTION

In a method and an apparatus for determining the molecular weight of polymers, a thin layer of a polymer, whose molecular weight is to be determined, is formed on a substrate, the thickness of the polymer layer is determined by an ellipsometer which is disposed above the substrate and the molecular weight is derived from the thickness of the polymer layer as determined by the ellipsometer.

With the method according to the invention utilizing the ellipsometric method the layer thickness can be determined rapidly and directly without contacting the layer. The layer thickness depends on the molecular weight of the polymer so that, using the ellipsometric method, the molecular weight can be derived directly from the layer thickness with an accuracy of about 10⁻⁹ m in a few seconds. Another important advantage of the method is that it can easily be automated so that the method can be used in industrial polymerization plants for the surveillance of the polymerization process al various points of such a plant. The method may of course also be used for quality surveillance and in the process control of a polymerization plant.

It is even possible with the method according to the invention to withdraw directly the product (polymer in solution) and provide therefrom the thin layer for determining the molecular weight and to employ the data derived therefrom for the process control of polymerization plants.

In accordance with an advantageous embodiment of the method according to the invention, the thin polymer layer is produced by a spin coating procedure. Basically, any procedure can be used for producing the thin polymer layer as long as it is capable of producing a sufficiently thin polymer layer. The spin coating procedure however has the advantage over other procedures that thin polymer layers can be produced thereby in a simple and highly accurately reproducible manner and in a very short time. In combination with the ellipsometric method for determining the thickness of the polymer layer produced by the spin coating procedure, the molecular weight of the polymer can be determined rapidly by the use of spin coating.

In order to make it possible after determining the layer thickness of the thin polymer layer and the molecular weight, to again examine the polymer using the method according to the invention, the polymer layer is preferably removed by a solvent from the substrate on which it had been formed, while the substrate is rotated. The polymer, dissolved by the solvent, is then removed from the substrate by the centrifugal forces acting on the polymer. Depending on the polymer, the solubility of the polymer and the solvent, the substrate is rotated for a period after the polymer has been removed so that also the solvent is evaporated from the substrate and the substrate is ready for the application of a new polymer solution ample for producing a new polymer layer.

An apparatus for determining the molecular weight of polymers, by which the described method can be performed, is characterized by an arrangement for providing a thin polymer layer as well as an ellipsometer for determining the thickness of the polymer layer. The ellipsometer for determining the layer thickness is arranged above the polymer layer.

With the apparatus according to the invention a so-called spin coater can be used for the preparation of the thin polymer layer that is a device can be used, with which, simply by rotation of a substrate on which a polymer solution has been placed, a uniform thin polymer layer can be rapidly formed. Furthermore, an ellipsometer, which is known per se, can be utilized as another apparatus component so that, by the combination of the two apparatus components, a relatively simply but highly effective apparatus combination is obtained, with which also the method according to the invention can be performed in a simple, rapid, effective and accurate manner.

Basically, however, the apparatus may include any type of equipment for producing a thin polymer layer as long as the layer thickness correlates to the molecular weight.

In order to prevent the evaporating solvent from depositing on the lenses of the ellipsometer during operation of the apparatus, that is, during the procedure in which the thin polymer layer is formed, the lenses can be covered so that they remain undisturbed for the subsequent ellipsometric examinations.

In accordance with another advantageous embodiment of the invention, the arrangement for producing the polymer layer includes at least one supply device for supplying a polymer solution to the substrate, which is rotated for forming the thin polymer layer. The supply device is capable of supplying a polymer solution to the substrate at the exactly proper time and in accurate amounts and in a reproducible manner for forming a thin polymer layer therefrom.

For the rapid removal of the thin polymer layer from the substrate after the examination of the polymer layer by means of the ellipsometer so as to be ready for the following examination of another new polymer layer, it is advantageous if the apparatus includes a supply device for the addition of a solvent to the rotating substrate. By way of this supply device, a solution suitable of dissolving the polymer forming the polymer layer is applied to the substrate in a dosed manner so that the polymer of the polymer layer is again dissolved and removed from the substrate. It may also be advantageous to continue the rotation of the substrate until there are no more solvent residues on the substrate.

An embodiment of the invention will be described below in greater detail on the basis of the accompanying schematic drawings.

### BRIEF DESCRIPTION OF THE DRAWINGS

FIG. 1a to FIG. 1d show schematically the various method steps for forming a thin polymer layer on a substrate using the spin coating procedure,

FIG. 2 shows, in a cross-sectional view, an apparatus for forming a thin polymer layer (spin coater), and

FIG. 3 is a cross-sectional view, like that of FIG. 2, wherein however also an ellipsometer is shown by way of which the layer thickness of the polymer layer on the substrate and the molecular weight of the polymer can be determined.

### DESCRIPTION OF A PREFERRED EMBODIMENT

First, reference is made to FIG. 2, in which a device 11 in the form of a spin coater for forming a thin polymer layer 12 is schematically shown in a cross-sectional view. The core of the device 10 is a rotatable table 21 on which a substrate 19 is disposed so as to extend essentially horizontally. The device 11 comprises a suctioning structure, which is indicated in the figure by the arrows extending from the device 10 vertically downwardly.

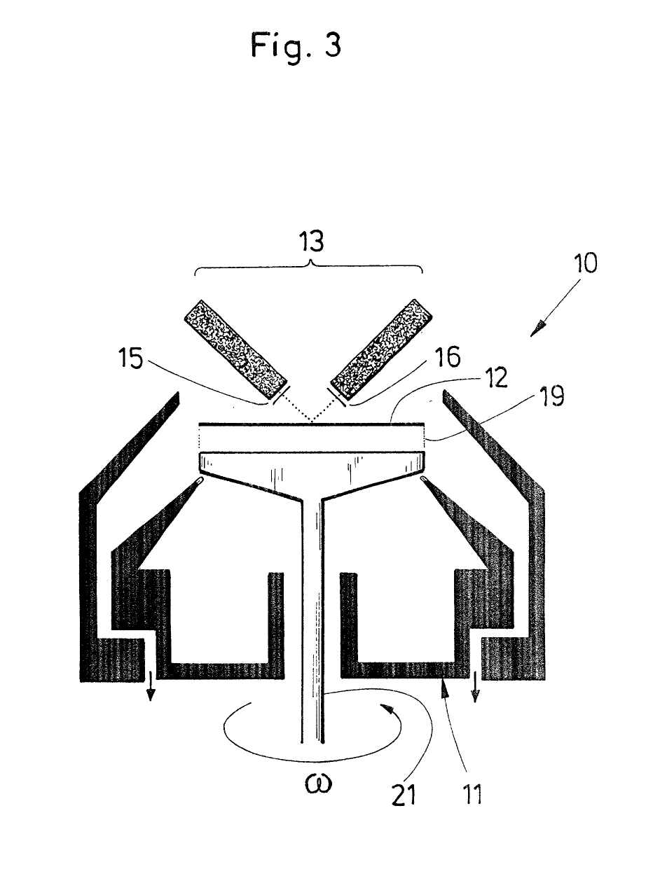

The device 10 comprises further an ellipsometer 13, see FIG. 3, which is arranged in a suitable manner above the substrate 19 on which the thin polymer layer 12 is disposed. The ellipsometer lenses 15, 16 are provided with covers, which can be placed in front of the lenses when necessary in order to protect the lenses from solvent vapors and polymer droplets, etc.

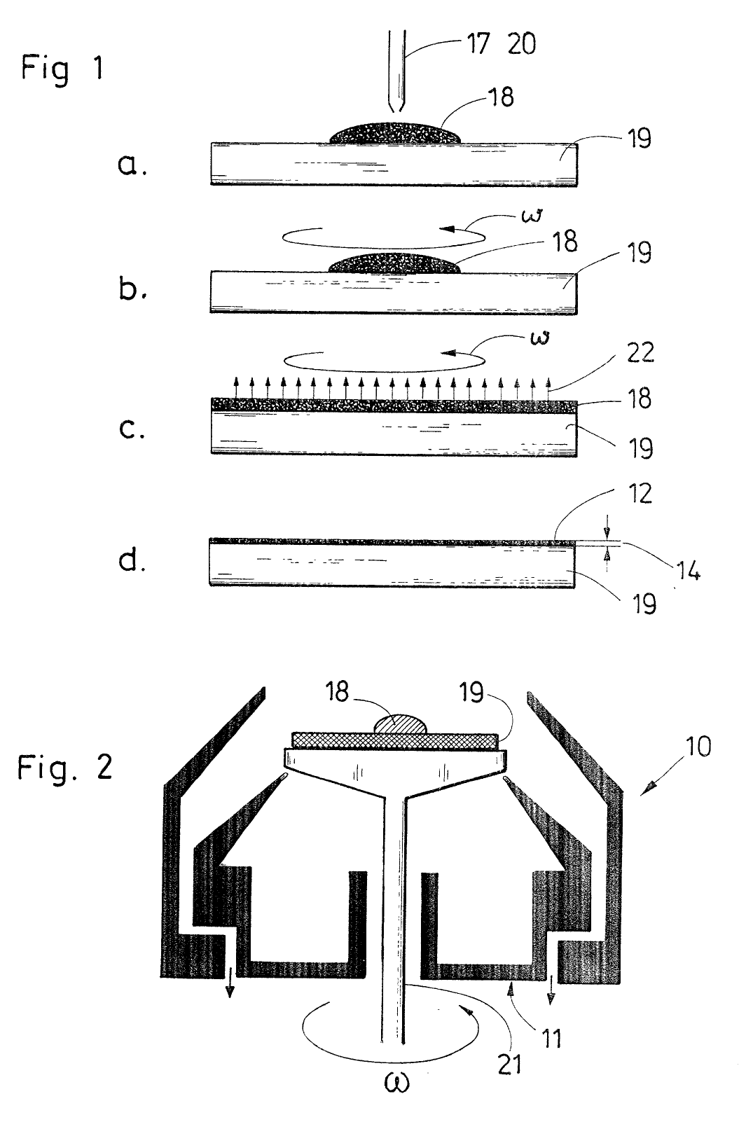

With regard to the description of the method according to the invention, reference is additionally made to FIGS. 1a to 1d.

Using a supplying structure 17, polymer solution 18 is deposited on substrate 19 in a suitably dosed manner. The rotatable table 21 is rotated together with the substrate 19 disposed thereon, see the rotational arrow ω. After the polymer solution 18 has spread as a result of the centrifugal forces generated by the timed rotation of the substrate 19, so as to form a layer from the polymer solution 18, see FIG. 1c, the solvent 22 is evaporated which is indicated symbolically in FIG. 1c by the arrows extending vertically therefrom. After evaporation of the solvent, a thin polymer layer 12 of a certain thickness 14 is disposed on the substrate 19, see FIG. 1d.

Then the layer thickness of the thin polymer layer 12 is determined by means of the ellipsometer 13. The ellipsometer 13 measures the polarization state of the light reflected from or respectively, within the polymer layer 12.

An evaluation of tilting of the ellipse from the incident Diane and the ratio of its large and small axes provides the ratio of the Fresnel-coefficient from which, by spectrally resolved measurements, the dielectric function is determined. When this function is known, the layer thickness of the thin layer can be determined by ellipsometry.

With the relationships

Layer thickness d˜[n]^{1/3}

and

[η]=KM^{a} (Staudinger equation)

the molecular weight of the polymer forming the polymer layer 12 can be derived, wherein

[η]=boundary viscosity number

K=constant [volume/mass]

a=constant, and

M=molecular weight

The constants K and a depend on the polymer or, respectively, the used solvent. The parameters K and a are provided in tables for almost any polymer-solvent system. They are given in the “Polymer Handbook Brandrup Immegut”. From the existing data banks, or respectively, the polymer handbook the respective parameters are available. A solvent can be selected, which provides a maximum value for the exponent a. This results in a maximum dependency of the layer thickness 14 on the molecular weight and accordingly the sensitivity of the process.

When the molecular weight has been determined, the thin polymer layer is removed from the substrate 19. To this end, see FIG. 1a, a certain amount of solvent 22 (a few ml) is applied to the thin polymer layer 12 by a supply device 20 and the table 21 together with the substrate 19 and, accordingly, the thin polymer layer 12 are rotated. Because of the centrifugal forces generated by the rotation the dissolving thin polymer layer 12 is removed from the substrate 19 and is removed by the suctioning arrangement 10 described earlier. The substrate 19 is rotated until neither polymer nor any solvent 22 is left on the substrate 19. Also during this removal step, the lenses 15, 16 of the ellipsometer 13 are covered by their covers, so that neither solvent nor polymer can reach the lenses. Solvent is admitted for the removal of the thin polymer layer 12 from the substrate 19 for example for a period of 5 to 10 sec.

The method as well as the apparatus 10 with all the predetermined steps described above can be controlled with the use of a computer so that the method can be performed and controlled in a fully automated manner.

What is claimed is:

1. A method for determining the molecular weight of polymers comprising the steps of: preparing a thin layer of the polymer whose molecular weight is to be determined, determining the thickness of said layer by an ellipsometric method and calculating, with the thickness determined by said ellipsometric method, the molecular weight of the polymer material using the relationship
layer thickness d˜[n]^{1/3}
and
[η]=KM^{a} (Staudinger equation)
wherein,
[η]=boundary viscosity number
K=constant [volume/mass]
A=constant, and
M=molecular weight

2. A method according to claim 1, wherein said thin layer is prepared on a substrate by a spin-coat process, wherein the substrate is rotated.

3. A method according to claim 2, wherein, after determining the thickness of the polymer layer, the layer is removed from said substrate by the application of a solvent.

4. A method according to claim 3, wherein, after removal of the polymer layer from the substrate by said solvent, said substrate is continued to be rotated for a predetermined time.

5. An apparatus for determining the molecular weight of polymers comprising a support structure supporting a substrate, an arrangement for providing on said substrate a thin layer of the polymer whose molecular weight is to be determined, and an ellipsometer disposed above said substrate for determining the thickness of said thin polymer layer disposed on said substrate.

6. An apparatus according to claim 5, wherein said ellipsometer has lenses provided with covers for protecting said lenses.

7. An apparatus according to claim 5, wherein said arrangement for providing said thin polymer layer includes means for supplying said polymer to said substrate and said substrate is supported by a support structure, which is rotatable about a vertical axis and which is rotated to subject the polymer supplied to said substrate to centrifugal forces for spreading said polymer on said substrate to form said thin layer.

8. An apparatus according to claim 7, wherein said arrangement includes means for supplying a solvent to said substrate for dissolving said polymer on said substrate and removing it therefrom while said support structure with said substrate disposed thereon is rotated.
